(19) United States
(12) Patent Application Publication
(10) Pub. No.: US 2002/0117397 A1
(43) Pub. Date: Aug. 29, 2002

(54) Exhaust oxygen sensor electrode formed with organo-metallic ink additives

(76) Inventors: Conrad H. Anderson, Davison, MI (US); Kerry J. Gross, New Lothrop, MI (US); Richard F. Beckmeyer, Davisburg, MI (US); William J. LaBarge, Bay City, MI (US)

Correspondence Address: Vincent A. Cichosz, DELPHI TECHNOLOGIES, INC., 1450 West Long Lake, Troy, MI, 48007, US

(21) Appl. No.: 09/738,640

(22) Filed: Dec. 15, 2000

(51) Int. Cl. G01N 27/407; C25B 11/08

(52) U.S. Cl. 204/424; 204/292

(57) ABSTRACT

The sensor comprises an electrode ink composition comprising a noble metal, and organo-metallic materials or combinations thereof. A solid electrolyte is disposed between a sensing electrode, exposed to a sensing gas such as an exhaust gas and a reference electrode, exposed to a reference gas.

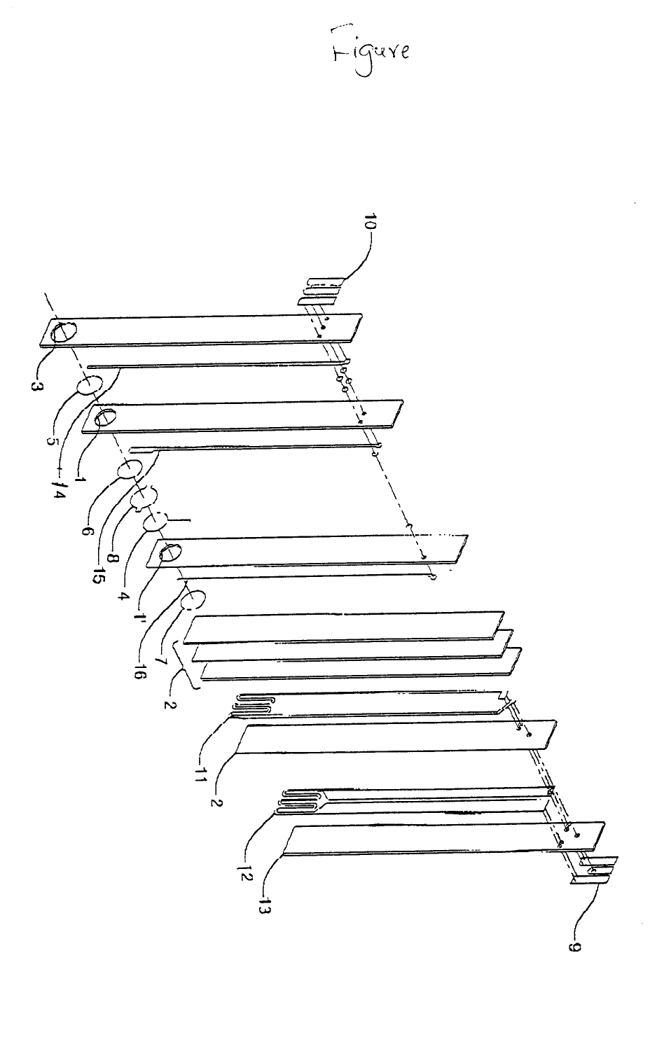

### TECHNICAL FIELD

The present disclosure relates generally to exhaust oxygen sensors capable of detecting oxygen. Particularly, the present disclosure relates to an electrode composition for an exhaust oxygen sensor.

### BACKGROUND

Exhaust sensors are used in the automotive industry to sense the composition of exhaust gases such as oxygen, hydrocarbons, and oxides of nitrogen, with oxygen sensors measuring the amounts of oxygen present in exhaust gases relative to a reference gas, such as air. A switch type oxygen sensor, generally, comprises an ionically conductive solid electrolyte material, a sensing electrode that is exposed to the exhaust gas, and a reference electrode that is exposed to the reference gas. It operates in a potentiometric mode, where oxygen partial pressure differences between the exhaust gas and reference gas on opposing faces of the electrochemical cell develop an electromotive force, which can be described by the Nernst equation:

$$E = ( \frac{RT}{4 F} ) ln ( \frac{{P}_{{O}_{2}}^{ref}}{{P}_{{O}_{2}}} )$$

where:

E=electromotive force

R=universal gas constant

F=Faraday constant

T=absolute temperature of the gas

P_{O2}^{ref}=oxygen partial pressure of the reference gas

P_{O2}=oxygen partial pressure of the exhaust gas

The large oxygen partial pressure difference between fuel rich and lean exhaust gas conditions creates a step-like difference in cell output at the stoichiometric point; the switch-like behavior of the sensor enables engine combustion control about stoichiometry. Stoichiometric exhaust gas, which contains unburned hydrocarbons, carbon monoxide, and oxides of nitrogen, can be converted very efficiently to water, carbon dioxide, and nitrogen by automotive three-way catalysts in automotive catalytic converters. In addition to their value for emissions control, the sensors also provide improved fuel economy and drivability.

Further control of engine combustion can be obtained using amperometric mode exhaust sensors, where oxygen is electrochemically pumped through an electrochemical cell using an applied voltage. A gas diffusion-limiting barrier creates a current limited output, the level of which is proportional to the oxygen content of the exhaust gas. These sensors typically consist of two or more electrochemical cells; one of these cells operates in potentiometric mode and serves as a reference cell, while another operates in amperometric mode and serves as an oxygen-pumping cell. This type of sensor, known as a wide range, lambda, or linear air/fuel ratio sensor, provides information beyond whether the exhaust gas is qualitatively rich or lean; it can quantitatively measure the air/fuel ratio of the exhaust gas.

The solid electrolyte commonly used in exhaust sensors is yttria-stabilized zirconia, which is an excellent oxygen ion conductor. The electrodes are typically platinum-based and porous in structure to enable oxygen ion exchange at electrode/electrolyte/gas interfaces. These platinum electrodes may be co-fired or applied to a fired (densified) electrolyte element in a secondary process, such as sputtering, plating, dip coating, etc. These electrodes can be made in the form of a film, paste, or ink and applied to the solid ceramic electrolyte in several ways. The ink is added either before the ceramic is fired (green), before the ceramic is fully fired (bisque) or after the ceramic is fully fired. Once the ink is added and fired, a strong bond should result between the fired ink and the ceramic body. In the case of an oxygen sensor, poor bonding between the platinum and the yttrium stabilized zirconia body can result in poor adhesion leading to poor sensor performance and unacceptable durability.

The poor adhesion is due to the different coefficients thermal expansion between the electrodes, the electrolyte, and the porous protective coating. For example, the platinum electrode has a different thermal expansion than the yttria- zirconia electrolyte. The varying degrees of thermal expansion results in a “pulling” phenomenon between the electrode and the electrolyte, increasing the debonding at the platinum and zirconia interface.

There exists a need in the art for an electrode formulation that can create a stronger bond and improve adhesion between the electrode and the electrolyte.

### SUMMARY

An electrode, sensor using the electrode, and methods for making the sensor and electrode and for using the sensor are disclosed herein. The electrode comprises: about 95 wt % to about 99 wt % noble metal, and about 1 wt % to about 5 wt % metal oxide, based upon the total weight of the electrode.

The method for making the electrode, comprises: forming an ink by combining about 34 wt % to about 99.5 wt % noble metal and up to about 66 wt % organo-metallic material, based upon the total weight of the ink; applying said ink to at least a portion of one side of a substrate; and heating to a temperature sufficient to sinter said metallic material.

The method for making a sensor, comprises: forming a first ink by combining about 34 wt % to about 99.5 wt % noble metal and up to about 66 wt % organo-metallic material, based upon the total weight of the first ink; applying said first ink to at least a portion of a first side of a first substrate; applying a second ink to at least a portion of a second side of a second substrate; connecting electrical leads to said first ink and said second ink; disposing an electrolyte between and in physical contact with said first ink and said second ink to form an assembly; forming a protective layer over said first substrate; and heating said assembly to a temperature sufficient to sinter said metallic material.

### BRIEF DESCRIPTION OF THE DRAWINGS

Reference is now made to the FIGURE, which is meant to be exemplary, not limiting.

The FIGURE is an example of an oxygen sensor.

### DESCRIPTION

Although the present invention will be described as an oxygen sensor, it is understood that the sensor could be a nitrous oxide sensor, hydrogen sensor, hydrocarbon sensor, or the like. Furthermore, while oxygen is the reference gas used in the description disclosed herein, it should be understood that other gases could be employed as the reference gas.

The sensor of the present invention is an electrode composition comprising noble metals, organo-metallic materials and, optionally, binders, thickeners and the like. The electrodes include a sensing electrode and a reference electrode with an electrolyte disposed therebetween. The sensor may further include protective layers, leads, a ground plane, contact pads, heaters, support layers, and the like.

The solid electrolyte can comprise any material conventionally employed for sensor electrolytes, such as metals, including, but not limited to, zirconium, cerium, yttrium, strontium, and the like; and metal oxides such as zirconia, yttia, ceria, strontia, barium cerium oxide, strontium cerium zirconates, barium cerium zirconates, and the like; as well as others, and combinations and alloys comprising at least one of the foregoing.

At least one, preferably both of the electrodes disposed on or adjacent to the electrolyte comprise a metal, such as a noble metal, and a metal oxide. Possible metals include platinum, gold, palladium, rhodium, iridium, osmium, ruthenium and mixtures and alloys comprising at least one of these metals, and other metals. Possible metal oxides include ceria, lanthana, magnesia, zirconia, yttria, alumina, scandia, and the like, and mixtures comprising at least one of the foregoing metal oxides, with yttria-zirconia, yttria-alumina, scandia-zirconia, scandia-alumina, yttria-alumina-zirconia, and scandia-alumina-zirconia preferred.

Typically, at least one, preferably both, electrodes comprise about 88 weight percent (wt %) to about 100 wt % noble metal and up to about 12 wt % metal oxide(s); with about 95 wt % to about 99 wt % noble metal and about 1 wt % to about 5 wt % metal oxides more preferred; and about 96 wt % to about 99 wt % noble metal and about 1 wt % to about 4 wt % metal oxides more preferred; and about 97 wt % or greater noble metal and about 3 wt % or less metal oxide especially preferred; based upon the total weight of the electrode after sintering.

Prior to sintering, the dried electrode composition generally comprises about 34 wt % to about 99.5 wt % noble metal and up to about 66 wt % organo-metallic material(s); with about 72 wt % to about 94 wt % noble metal and about 6 wt % to about 28 wt % organo-metallic material(s), preferred; and about 83 wt % to about 94 wt % noble metal and about 6 wt % to about 17 wt % organo-metallic material(s) especially preferred; based on the total weight of the dried electrode.

Although the electrode(s) can be formed in a conventional fashion, it is preferable to prepare the electrode material in the form of ink, by forming a slurry, paste, or the like, according to known techniques. For example, the noble metal can be mixed with a sufficient quantity of the organo-metallic material to attain the desired adhesion, upon firing, between the electrode and the surface on which it is disposed (e.g., the electrolyte, a porous material, and/or a dielectric layer). Possible organo-metallic materials include: zirconium 2-ethyl hexanoate (e.g., zirconium Hex Cem (6 carbon chain) commercially available from OMG America); zirconium neodecanoates (e.g., zirconium Ten Cem (10 carbon chain) commercially available from OMG America); zirconium naphthenates (e.g., zirconium Nap All commercially available from OMG America); zirconium tallates (e.g., zirconium Lin All commercially available from OMG America); a mixture of zirconium carboxylates (e.g., zirconium Cem All commercially available from OMG America); yttrium 2-ethyl hexanoate (e.g., yttrium Hex Cem (6 carbon chain) commercially available from OMG America); yttrium neodecanoates (e.g., yttrium Ten Cem (10 carbon chain) commercially available from OMG America); yttrium naphthenates (e.g., yttrium Nap All commercially available from OMG America); yttrium tallates (e.g., yttrium Lin All commercially available from OMG America); a mixture of yttrium carboxylates (e.g., yttrium Cem All commercially available from OMG America); scandium 2-ethyl hexanoate, commercially available from OMG America; aluminum isopropoxide commercially available from Chemat Technology, aluminum 2-ethylhexanoate(made in-house from reaction of aluminum isopropoxide and 2-ethylhexanoic acid), and aluminum 2-methoxyethanol, and the like, as well as combinations comprising at least one of the foregoing.

Once prepared, the ink can be applied to the desired area of the sensor, typically the electrolyte or a layer adjacent to the electrolyte such as a dielectric layer, through conventional techniques such as screen printing, painting, spraying, dipping, coating, or the like. Depending upon the technique employed, optional thickeners, binders, additives, and the like (hereinafter additives), may be employed in the ink in an amount of up to about 28 wt % additives for screen printing, 60 wt % additives for pad flexing (painting), 75 wt % additives for spray coatings, 90 wt % additives for dip coatings. Some such additives include: 1-ethoxypropan-2-ol, turpentine, squeegee medium, 1-methoxy-2-propanol acetate, butyl acetate, dibutyl phthalate, fatty acids, acrylic resin, ethyl cellulose, 3-hydroxy, 2,2,4-trimethylpentyl isobutyrate, terpineol, butyl carbitol acetate, cetyl alcohol, cellulose ethylether resin, and the like, as well as combinations comprising at least one of the foregoing.

Furthermore, the ink can be applied during any point during the manufacturing process; i.e., before the electrolyte is fired (green), before the electrolyte is fully fired (bisque), or after the electrolyte is fully fired. In each case, however, once the ink has been applied, the electrolyte is heated to a temperature sufficient to sinter the organo-metallic coating, thereby enabling noble metal to noble metal contact. For an organometallic coating comprising zirconia, for example, temperatures of about 1,300° C. or greater are typically employed to sinter the coating.

For example, an electrode can be produced by pre-firing the electrolyte containing layer in a conventional oven at about 800° C. to about 1,200° C. for up to about 60 minutes, to render it in a bisque state. The ink can then be applied to the bisque layer, preferably to obtain a substantially uniform ink coating around the surface of the electrolyte. Once applied, the ink is heated to a temperature sufficient to volatilize the organics and preferably sinter the metallic component of the organo-metallic material. For example, for zirconium 2-ethylhexanoate and yttrium 2-ethylhexanoate (i.e., an ink containing 8 mole %), a temperature exceeding about 1,400° C. is typically employed, with a temperature of about 1500° C. to about 1510° C. preferred, for up to about 2 hours or so.

Not to be limited by theory, it is believed that the organo-metallic material absorbs (or otherwise penetrates) into the surface of the electrolyte, enhancing the adhesiveness between the electrolyte and the electrode. Upon sintering, the metallic component of the organo-metallic material, for example zirconium, forms into a cluster, enabling electrical communication between the catalyst particles, e.g., and the noble metal.

Referring to the FIGURE, the sensor comprises a pumping cell and a reference cell. The pumping cell comprises an electrolyte (1) disposed between an outer electrode (5) and an inner electrode (6). Disposed on the side of said sensing electrode (4), opposite said electrolyte (1), is a protective layer (3). Meanwhile, disposed between the pumping cell and reference cell, particularly between the inner electrode (6) and the sensing electrode (4) is a porous diffusion restriction (8).

The reference cell comprises the sensing electrode (4) and reference electrode (7), with electrolyte (1′) disposed therebetween. On the side of the reference electrode (7) opposite the electrolyte (1′) are support layers (2), ground plane (11), heater (12), and protective layer (13). The electrodes (4, 5, 6, 7) are connected to contacts (9, 10), via leads (14, 15, 16). It should be noted that the support layers (2), ground plane (11), heater(s) (12), contacts (9, 10), and leads (14, 15, 16) can be composed of materials conventionally used in sensors.

For example, the support layers can comprise a dielectric material, such as metal oxide, e.g., alumina or the like, while the heaters, leads, and contacts can comprise a thermally and electrically conductive metal such as a precious metal(s), e.g. platinum, palladium, rhodium, iridium, osmium, ruthenium, and the like, as well as combinations and alloys comprising at least one of the foregoing.

These sensors, and others comprising more or less cells, can be formed in any conventional fashion where the components are formed and fired separately or formed, laminated, and then fired. For example, an electrolyte tape is formed and partially fired to place it in the bisque state. Electrode ink is prepared as described above and deposited on the appropriate portions of each side of the electrolyte tape and connecting electrical leads to the ink. A protective layer can then be disposed on one side of the electrolyte tape, while a series of support layers with a ground plane and heater disposed therein, can be disposed on the opposite side of the electrolyte tape. The lay-up is then heated to a sufficient temperature to sinter the organo-metallic material in the ink, thereby forming the sensor.

In one embodiment, during use, the sensor is typically disposed in the stream to be sensed, e.g., the exhaust stream. Based upon the condition of the stream, i.e. rich or lean, oxygen is pumped in or out of the sensor by the pumping cell. The increase/decrease, accordingly, creates an oxygen partial pressure difference between the oxygen at the sensing electrode and at the reference electrode; thereby developing an electromotive force.

The following example is provided for further illustration.

### EXAMPLES

### Example 1

The following example was employed to produce an electrode comprising 1.19 wt % zirconium oxide 0.06 wt % yttrium oxide and 98.75 wt % platinum.

An ink was prepared by mixing 40 wt % toluene with 60 wt % solids; 60 grams (g) platinum, 6.6 g of 18% zirconium 2-ethylhexanoate, 0.33 grams of 18% yttrium 2-ethylhexanoate, per 100 g ink. To the ink, 5.0 g cellulose ethylether resin, 6.0 g dibutyl phthalate, 5.0 g butyl acetate, and 17.0 g terpineol was added.

Meanwhile, an electrolyte tape comprising 8 wt % yttrium oxide, 4 wt % aluminum oxide and 88 wt % zirconium dioxide was pre-fired at 1,000° C. for 40 minutes and cooled to place it in the bisque state. The ink was then applied to the cooled tape in the desired areas. The inked tape was heated to 1 ,500° C. for 75 minutes to sinter the zirconia and remove organics, thereby forming an electrode/electrolyte subassembly.

### Example 2

The following example can be employed to form a conical sensor having magnesia-alumina spinel porous protective coating with a coefficient of thermal expansion (CTE) of about 8.8 micrometers per meter-degree Celcius (um/m° C.) over a co-fired 0.24 wt % scandia- 2.76 wt % zirconia- 97.0 wt % platinum electrode.

The electrode ink contained 1.0 g of 18% scandium 2-ethylhaxanote in toluene, 11.0 g of 18.0% zirconium 2-ethylhexanoate in toluene, 70.0 g of platinum powder, 5.0 g cellulose ethylether resin, 6.0 g dibutyl phthalate, 5.0 g butyl acetate and 17.0 g terpineol. The ink can be screen printed over a bisque element heated to 1100° C. The inked element is heated to about 1500° C. for 2 hours. The co-fired electrode has a CTE of about 10.5 m/m° C. The partially stabilized 3.8% alumina-8.5% yttria-87.7% zirconia body has a CTE of about 10.5 um/m° C. In other words, the metal oxide comprises about 0.05 wt % to about 1 wt % scandia and about 0.95 wt % to about 3 wt % zirconia.

### Example 3

The following example can be employed to form a conical sensor has magnesia-alumina spinel porous protective coating with a CTE of about 8.8 um/m° C. over a co-fired 0.12% alumina-0.33% scandia-2.55% zirconia-97.0% platinum electrode.

The electrode ink contained 0.6 g of 15.0% aluminum 2-methoxyethanol in 2-methoxyethanol, 1.3 g of 18% scandium 2-ethylhaxanote in toluene, 10.2 g of 18.0% zirconium 2-ethylhexanoate in toluene, 70.0 g of platinum powder, 5.0 g cellulose ethylether resin, 6.0 g dibutyl phthalate, 5.0 g butyl acetate and 17.0 g terpineol. The ink can be screen printed over a bisque element heated to about 1100° C. The inked element is heated to about 1500° C. for about 2 hours. The co-fired electrode has a CTE of about 10.1 m/m° C. over a partially stabilized 3.8% alumina-8.5% yttria-87.7% zirconia body with a CTE of about 10.5 um/m° C. In other words, the metal oxide comprises about 0.05 wt % to about 0.5 wt % scandia, 0.05 wt % to about 0.5 wt % alumina, and about 0.9 wt % to about 3 wt % zirconia.

### Example 4

The following example can be employed to form a conical sensor can have a magnesia-alumina spinel porous protective coating having a CTE of about 8.8 um/m°C. over a co-fired 1.32% scandia-1.68% alumina-97% platinum electrode.

The electrode ink contained 6.3 g of 18% scandium 2-ethylhexanoate in toluene, 11.0 g of 15% aluminum 2-methoxyethanol in 2-methoxyethanol, 70.0 g of platinum powder, 5.0 g cellulose ethylether resin, 6.0 g dibutyl phthalate, 5.0 g butyl acetate and 17.0 g terpineol. The ink was screen printed over a bisque element heated to about 1100 ° C. The inked element is heated to about 1500° C. for about 2 hours. The co-fired electrode has a CTE of about 10.1 m/m°C. over a partially stabilized 3.8% alumina-8.5% yttria-87.7% zirconia body having a CTE of about 10.5 um/m°C. In other words, the metal oxide comprises up to about 0.5 wt % to about 2 wt % scandia and about 0.5 wt % to about 2 wt % zirconia.

### Example 5

The following example can be employed to form a conical sensor has magnesia-alumina spinel porous protective coating having a CTE of about 8.8 um/m°C. over a co-fired 0.24% yttria-2.76% zirconia-97% platinum electrode.

The electrode ink contained 1.6 g of 11% of yttrium 2-ethylhaxanote in toluene, 11.0 g of 18.0% zirconium 2-ethylhexanoate in toluene, 70.0 g of platinum powder, 5.0 g cellulose ethylether resin, 6.0 g dibutyl phthalate, 5.0 g butyl acetate and 17.0 g terpineol. The ink was screen printed over a bisque element heated to 1100° C. The inked element was heated to about 1500° C. for about 2 hours. The co-fired electrode having a CTE of about 10.7 m/m°C. over a partially stabilized 3.8% alumina-8.5% yttria-87.7% zirconia body having a CTE of about 10.5 um/m°C. In other words, the metal oxide comprises up to about 0.05 wt % to about 1 wt % yttria and about 0.95 wt % to about 3 wt % zirconia.

Sample A: Sputtered Sensor

A spray dried powder consisting of 8 wt % yttria, 4 wt % alumina and 88 wt % zirconia is made. The powder is molded and ground into a conical shape. The ground body is heated to 1500° C. for 2 hours. The fired body has an inner stripe of Pt/Bi₂O₃ applied. The body/inner stripe is heated to 1000° C. for 1 hour. An outer stripe of Pt/PbO/B₂O₃ was pad flexed on the sensor. The sensor is heated to 1000° C. for 1 hour. The body/inner stripe/outer stripe is loaded into a sputtering unit. A deposit of about 10 mg platinum is deposited on the sensor tip. The sensor is treated in a neutral (N₂) or reducing (N₂/H₂) atmosphere at 800° C. for 1 hour. A 100 micron thick porous protective coating of magnesium alumina spinel is plasma sprayed on the sensor tip.

Sample B: Conventional Conical Sensor (Purchased

A spray dried powder of unknown composition of yttria-zirconia is made (3 to 12 wt % yttria possible). The powder is molded and ground into a conical shape. The ground body is fired to an unknown temperature (1300 to 1600° C. possible). The fired body is electroless plated with a pure Pt inner and outer electrode. The post plating treatment is unknown. A magnesium-alumina spinel layer is thermally applied. A fine alumina is applied. A coarse alumina layer is applied.

Sample C: Conventional Co-fired Sensor (No Organometallic)

A spray dried powder consisting of 8 wt % yttria, 4 wt % alumina, 88 wt % zirconia was made. The powder was molded and ground into a conical shape. The ground body is fired to 1000° C. for 1 hour. The outer sensor tip was dipped in a 15 wt% Pt solution made from a Pt ink without zirconium hex-cem diluted with ethanol. The inner sensor was filled and drained with a 15 wt % Pt solution made from a Pt ink without zirconium hex-cem diluted with ethanol. The sensor was heated to 1500° C. for 2 hours. A 100 micron thick porous protective coating of magnesium alumina spinel is plasma sprayed on the sensor tip.

Sample D: Co-fired Sensor with Organometallic.

A spray dried powder consisting of 8 wt % yttria, 4 wt % alumina, 88 wt % zirconia was made. The powder was molded and ground into a conical shape. The ground body was fired to 1000° C. for 1 hour. The outer sensor tip was dipped in a 15 wt % Pt solution made from a Pt ink containing as a fired residue 1.19 weight % zirconium dioxide from zirconium hex-cem and 0.06 wt % yttrium oxide from yttrium hex-cem. The inner sensor was filled and drained with a 15 wt % Pt solution made from a Pt ink containing as a fired residue 1.19 wt % zirconium dioxide from zirconium hex-cem and 0.06 wt % yttrium oxide from yttrium hex-cem. The sensor was fired to 1500° C. for 2 hours. A 100 micron thick porous protective coating of magnesium alumina spinel was plasma sprayed on the sensor tip.

The sensors were tested on a 2.3 L Oldsmobile L-4 engine running a steady state schedule. The sensors are set up to have an exhaust stream temperature of 800° C.±10° C. The engine was run open loop with the load adjusted to obtain an A/F ratio of 12:1±0.3 A/F. The test duration for life of vehicle durability was 200 hours, wherein 200 hours of test duration simulates 50,000 mile durability.

Table 1 sets forth the hours of aging as well as the results for the various samples.

TABLE 1

| | Hot Rich Aging (hours) | | | | | |
|---|---|---|---|---|---|---|
| Sample | 0 | 100 | 200 | 300 | 400 | 500 |
| A (ohms) | 1,000 | 3,000 | 7,000 | 15,000 | open | open |
| B (ohms) | 1,000 | 3,000 | 7,000 | 15,000 | 25,000 | open |
| C (ohms) | 1,000 | 1,000 | 1,400 | 1,800 | 3,000 | 7,000 |
| D (ohms) | 1,000 | 1,000 | 1,000 | 1,200 | 1,500 | 1,500 |

As is clear from Table 1, even after 500 hours of aging, the organo-metallic co-fired electrode, Sample D, maintained a low resistance of 1,500 ohms even after 500 hours of aging at about 800° C. (±10° C.) with an air/fuel mixture of about 12 (±0.3), a factor of more than four times better than the closest prior art electrode, Sample C. Consequently, even though the organo-metallic co-fired electrode possess low metal oxide content, it has a resistance of less than about 5,000 ohms, with less than about 2,500 ohm preferred, and less than about 2,000 readily attainable after 500 hours of hot rich aging (e.g., at about 800° C. (±10° C.) with an air/fuel mixture of about 12 (±0.3)).

Table 2 sets forth performance, i.e. response times, lean (L) to rich (R) and vice versa, in milliseconds (ms) for the above defined samples, at 0.5 hertz (Hz) and 260° C.

TABLE 2

| Sample | LR (ms) | RL (ms) | LR lag (ms) | RL lag (ms) |
|---|---|---|---|---|
| A | 33 | 75 | 53 | 10 |
| B | 62 | 132 | 200 | 41 |
| C | 52 | 125 | 32 | 65 |
| D | 34 | 75 | 17 | 15 |

As can be seen from Table 2, the organo-metallic co-fired electrode, Sample D, exhibited similar LR and RL response times to the sputtered electrode, Sample A, while improving LR lag by a factor of more than 3 while retaining low RL lag time. Furthermore, with respect to the other two Samples, B and C, Sample D exhibited significant improvement.

Table 3 sets forth performance, i.e. response times, LR and RL, in milliseconds (ms) for the above defined samples, at 2 Hz and 595° C.

TABLE 3

| Sample | LR (ms) | RL (ms) | LR lag (ms) | RL lag (ms) |
|---|---|---|---|---|
| A | 21 | 31 | 25 | 3 |
| B | 39 | 91 | 46 | 52 |
| C | 36 | 120 | 32 | 65 |
| D | 23 | 24 | 27 | 7 |

As can be seen from Table 3, as with Table 2, the organo-metallic co-fired electrode, Sample D, exhibited low LR, RL, LR lag and RL lag, similar to that of the sputtered electrode, Sample A, while showing significant improvements over the plated and standard co-fired electrodes, Samples B and C respectively. Under all conditions, the organo-metallic co-fired electrode had a response time of less than about 30 ms.

Based upon the results set forth in the above Tables, the organo-metallic co-fired electrode is a substantial improvement over the prior art electrodes since it exhibits substantially improved resistance after hot rich aging, yet retains now response times, LR, RL, LR lag, and RL lag, at both 0.5 Hz 260° C. and at 2 Hz 595° C. In contrast, the plated electrode exhibited good response times, however, very poor resistance after hot rich aging, while the standard co-fired electrode exhibited better resistance after hot rich aging, yet poor performance, particularly RL and RL lag under both testing conditions.

Not to be limited by theory, it is believed that the organo-metallic is efficient in coating the platinum. The organo-metallic is typically included as a viscous liquid, essentially little or no solids, which coats the platinum particles. Upon heating the organo-metallic decomposes to zirconium oxide and yttrium oxide, leaving the platinum particles surrounded, seemingly substantially completely, with a thin layer (e.g., about 2 to about 10 nanometers) of zirconium oxide and yttrium oxide. The platinum particles cannot touch because of their “protective” coating, thus the platinum particles cannot sinter until high temperatures about 1,450° C. or greater. By the time the zirconia sinters, e.g, forms into small “balls”, the electrode morphology substantially determined. Consequently, the resulting electrode is open and porous. Essentially, the platinum particles were not able to physically contact one another until the electrode firing was nearly complete. This results in an electrode possessing good adhesion and scratch resistance, as well as being highly effective (a resistance of less than 2,000 even after 500 hours of hot rich aging at 800±10° C. with an A/F ratio of 12:1±0.3 A/F; and low LR, RL, LR lag, and RL lag times) and possessing a substantially increased number of triple points (greater than about 10% of the zirconia triple points available, with about 20% or greater typical).

It should be noted that a conventionally sintered electrode with a given amount of platinum is 2.0 to 3.0 micrometers thick, while a sputtered electrode is about 2 micrometers at the thinnest part near the base and 8 micrometers at the thickest part which is the tip. In contrast, a conical sensor with a dipped zirconium organometallic electrode with the same amount of platinum loading for a given surface area is 6.0 to 7.0 micrometers thick at the thinnest part near the base and 20 micrometers at the thickest part which is the tip.

Similar to the conventional sintered electrode, a co-fired platinum only, screen printed, flat plate electrode with a given amount of platinum is 2.0 to 5.0 micrometers thick. In contrast, a zirconium hex-cem and platinum containing screen printed flat plate sensor electrode with the same amount of platinum loading for a given surface area is 6.0 to 10.0 micrometers thick. Additionally, conventional electrode porosities are about 13% porosity (plated electrode) to about 18% porosity (sputtered and co-fired electrodes), while the organo-metallic formed electrode has a porosity exceeding about 20% with greater than about 25% preferred, about 31% commonly obtained. Considering the porosities and thickesses, the organo-metallic formed sensor has a porosity of two to three times greater than a conventional electrode.

Another advantage of the organo-metallic formed sensor relates to the triple points. A triple point is a location where exhaust gas has access to both platinum on the electrode and exposed yttria-zirconia of the electrolyte. Without exposed zirconia, the sensor will not function. The more of the electrolyte that is covered by platinum, the few number of active sites available for sensing. A conventional co-fired electrode, for example, has only 3 to 5% of the zirconia triple points available for sensing, while a standard sputtered electrode has about 9% of total surface area as active yttria-zirconia triple points. In contrast, the organo-metallic formed electrode has greater than about 10% of the zirconia triple points available for sensing, with about 16% or greater common and preferred; i.e., at least about three times more than the conventional co-fired sensor.

In contrast to the present electrode, a conventional electrode will form a very dense platinum, e.g., because the platinum particles have been in physical contact throughout the firing process. The conventional electrode has particulate zirconia of about 1 micron in size.

While preferred embodiments have been shown and described, various modifications and substitutions may be made thereto without departing from the spirit and scope of the invention. Accordingly, it is to be understood that the present invention has been described by way of illustration only, and such illustrations and embodiments as have been disclosed herein are not to be construed as limiting to the claims.

What is claimed is:

1. An electrode composition, comprising:
about 95 wt % to about 99 wt % noble metal, and about 1 wt % to about 5 wt % metal oxide, based upon the total weight of the electrode.

2. The electrode composition of claim 1, wherein the electrode has a resistance after 500 hours of less than about 5,000 ohms after 500 hours of hot rich aging at about 800° C. with an air/fuel mixture of about 12.0.

3. The electrode composition of claim 2, wherein the electrode has a resistance of less than about 2,500 ohms.

4. The electrode composition of claim 3, wherein the electrode has a resistance of less than about 2,000 ohms, and a lean to rich response time at 0.5 Hz and 260° C. of less than about 40 ms.

5. The electrode composition of claim 4, wherein the electrode has a lean to rich response time and a rich to lean response time, at 2 Hz and 595° C. of less than about 30 ms.

6. The electrode composition of claim 1, further comprising: about 96 wt % to about 99 wt % noble metal and about 1 wt % to about 4 wt % metal oxide, based upon the total weight of the electrode.

7. The electrode composition of claim 6, further comprising: greater than about 97 wt % noble metal, and about 3 wt % or less metal oxide, based upon the total weight of the electrode.

8. The electrode composition of claim 1, wherein said noble metal is selected from the group consisting of platinum, palladium, rhodium, iridium, osmium, ruthenium, and mixtures and alloys comprising at least one of the foregoing.

9. The electrode composition of claim 1, wherein said metal oxide is selected from the group consisting of zirconium oxide, yttrium oxide, ceria, alumina, boron carbide, and mixtures and alloys comprising at least one of the foregoing.

10. The electrode composition of claim 1, further comprising about 1 wt % to about 4 wt % scandia-zirconia.

11. The electrode composition of claim 10, further comprising about 0.05 wt % to about 1 wt % scandia and about 0.95 wt % to about 3 wt % zirconia.

12. The electrode composition of claim 11, wherein the noble metal is platinum.

13. The electrode composition of claim 1, further comprising about 1 wt % to about 4 wt % scandia-alumina-zirconia.

14. The electrode composition of claim 13, further comprising about 0.05 wt % to about 0.5 wt % scandia, about 0.05 wt % to about 0.5 wt % alumina, and about 1 wt % to about 3 wt % zirconia.

15. The electrode composition of claim 14, wherein the noble metal is platinum.

16. The electrode composition of claim 1, further comprising about 0.05 wt % to about 1 wt % yttria and about 0.95 wt % to about 3 wt % zirconia.

17. A sensor, comprising:
a sensing electrode;
a reference electrode; and
an electrolyte disposed between and in intimate contact with said sensing electrode and said reference electrode;
wherein at least one of said sensing electrode and said reference electrode comprises about 95 wt % to about 99 wt % noble metal, and about 1 wt % to about 5 wt % metal oxide, based upon the total weight of the electrode.

18. A method of making an electrode, comprising:
forming an ink by combining about 34 wt % to about 99.5 wt % noble metal and up to about 66 wt % organo-metallic material, based upon the total weight of the ink;
applying said ink to at least a portion of one side of a substrate; and
heating to a temperature sufficient to sinter said metallic material.

19. A method of making an electrode as in claim 18, further comprising combining up to about 90 wt % additive with said ink, based upon the total weight of the ink.

20. A method of making an electrode as in claim 18, wherein said additives are selected from the group consisting of 1-ethoxypropan-2-ol, turpentine, squeegee medium, 1-methoxy-2-propanol acetate, butyl acetate, dibutyl phthalate, fatty acids, acrylic resin, ethyl cellulose, 3-hydroxy,2,2,4-trimethylpentyl isobutyrate, terpineol, butyl carbitol acetate, cetyl alcohol, cellulose ethylether resin, and combinations comprising at least one of the foregoing.

21. A method of making an electrode of claim 18, about 72 wt % to about 94 wt % noble metal and about 6 wt % to about 28 wt % organo-metallic material.

22. A method of making an electrode of claim 21, wherein said ink about 83 wt % to about 94 wt % noble metal and about 6 wt % to about 17 wt % organo-metallic material.

23. A method of making an electrode of claim 22, wherein the electrode has a resistance of less than about 5,000 ohms after 500 hours of hot rich aging at about 800° C. with an air/fuel mixture of about 12.0.

24. A method of making an electrode of claim 23, wherein the electrode has a resistance of less than about 2,500 ohms.

25. A method of making an electrode of claim 24, wherein the electrode has a resistance of less than about 2,000 ohms, and a lean to rich response time at 0.5 Hz and 260° C. of less than about 40 ms.

26. A method of making an electrode of claim 25, wherein the electrode has a lean to rich response time and a rich to lean response time, at 2 Hz and 595° C., of less than about 30 ms.

27. A method of making a sensor, comprising:
forming a first ink by combining about 34 wt % to about 99.5 wt % noble metal and up to about 66 wt % organo-metallic material, based upon the total weight of the first ink;
applying said first ink to at least a portion of a first side of a first substrate;
applying a second ink to at least a portion of a second side of a second substrate;
connecting electrical leads to said first ink and said second ink;
disposing an electrolyte between and in physical contact with said first ink and said second ink to form an assembly;
forming a protective layer over said first substrate; and
heating said assembly to a temperature sufficient to sinter said metallic material.

28. A method of making a sensor as in claim 27, further comprising disposing a heater in thermal communication with said electrolyte and said second side.

29. A method of making a sensor as in claim 27, wherein said first ink comprises about 72 wt % to about 94 wt % noble metal and about 6 wt % to about 28 wt % organo-metallic material.

30. A method of making a sensor as in claim 29, wherein said first ink about 83 wt % to about 94 wt % noble metal and about 6 wt % to about 17 wt % organo-metallic material.

31. A method of making a sensor as in claim 27, further comprising partially firing said substrate.

32. A method of making a sensor as in claim 27, wherein said first substrate and said second substrate are the electrolyte.

33. A method of sensing exhaust gas, comprising:
using a sensor comprising a sensing electrode, a reference electrode, an electrolyte disposed between and in intimate contact with said sensing electrode and said reference electrode, wherein at least one of said sensing electrode and said reference electrode comprises about 95 wt % to about 99 wt % noble metal, and about 1 wt % to about 5 wt % metal oxide, based upon the total weight of the electrode;
disposing said sensor in an exhaust stream;
contacting said sensing electrode with exhaust gas; and
creating an electromotive force.
